(19) United States
(12) Patent Application Publication
(10) Pub. No.: US 2013/0235713 A1
(43) Pub. Date: Sep. 12, 2013

(54) OPTICAL RECORDING MEDIUM DRIVING APPARATUS AND CROSS TRACK SIGNAL GENERATION METHOD

(71) Applicant: SONY CORPORATION, Tokyo (JP)

(72) Inventor: Yuuichi Suzuki, Kanagawa (JP)

(73) Assignee: Sony Corporation, Tokyo (JP)

(21) Appl. No.: 13/769,989

(22) Filed: Feb. 19, 2013

(30) Foreign Application Priority Data
Mar. 6, 2012 (JP) 2012-048978

(51) Int. Cl. G11B 7/00

(52) U.S. Cl. CPC G11B 7/00
USPC 369/100

(57) ABSTRACT

Provided is an optical recording medium driving apparatus including a light radiating unit that radiates light to an optical recording medium, a light receiving unit that receives reflection light from the optical recording medium, in which four regions including a first region, a second region, a third region, and a fourth region are formed by being divided by a linear direction division line and a tracking direction division line, a first binarizing unit that obtains binarization signals, a first exclusive OR calculating unit, a second exclusive OR calculating unit, and an operation unit. The first and second exclusive OR calculating units and the operation unit operate in a state not synchronized with a channel clock.

### BACKGROUND

The present disclosure relates to an optical recording medium driving apparatus that reproduces at least with respect to an optical recording medium and a cross track signal generation method.

Recently, a disc-shaped optical recording medium (hereinafter, simply referred to as an optical disc) such as a compact disc (CD), a digital versatile disc (DVD), and a Blu-ray disc (BD: registered trademark) has spread widely.

In the optical disc, a cross track signal may be used when a tracking servo is pulled.

A cross track signal is a sine wave of which a phase is different from a phase of a tracking error signal by 90° (a degree corresponding to a ¼ track pitch) and is used to distinguish two zero-cross points obtained in the tracking error signal, that is, a zero-cross point corresponding to track centers and a zero-cross point corresponding to a center point between the track centers.

By performing pulling control using the cross track signal, pulling of the tracking servo can be performed stably with respect to the track center.

### SUMMARY

As described in Japanese Patent Application Laid-Open Nos. 2002-92935 and H10-269593, a total light amount signal (sum signal of light reception signals by division detectors) has been used as the cross track signal.

However, the total light amount signal functions as the cross track signal, when an optical disc provided with grooves (continuous grooves) is used. In a reproduction dedicated disc in which grooves are not formed and tracks based on pit rows are formed, the total light amount signal may not be used as the cross track signal.

It is desirable to obtain an appropriate cross track signal to correspond to a reproduction dedicated optical recording medium in which tracks based on pit rows are formed.

According to an embodiment of the present invention, there is provided the following configuration for an optical recording medium according to an embodiment of the present disclosure.

That is, that according to an embodiment of the present disclosure, there is provided an optical recording medium driving apparatus including a light radiating unit that radiates light to an optical recording medium.

Further, according to an embodiment of the present disclosure, there is provided an optical recording medium driving apparatus including a light receiving unit that receives reflection light from the optical recording medium, in which four regions including a first region, a second region, a third region, and a fourth region are formed by being divided by a linear direction division line extending in a direction corresponding to a longitudinal direction of a track formed in the optical recording medium and a tracking direction division line extending in a direction corresponding to a short-side direction of the track, the first region and the second region, and the third region and the fourth region being segmented by the linear direction division line, the first region and the fourth region, and the second region and the third region being segmented by the tracking direction division line, the first region and the second region being arranged on an upstream side based on an advancement direction of the track, and the third region and the fourth region being arranged on a downstream side based on the advancement direction of the track

Further, according to an embodiment of the present disclosure, there is provided an optical recording medium driving apparatus including a first binarizing unit that obtains binarization signals based on light reception signals obtained in the respective first to fourth regions in the light receiving unit as a first signal, a second signal, a third signal, and a fourth signal, respectively.

Further, according to an embodiment of the present disclosure, there is provided an optical recording medium driving apparatus including a first exclusive OR calculating unit that calculates an exclusive OR of the first signal and the third signal.

Further, according to an embodiment of the present disclosure, there is provided an optical recording medium driving apparatus including a second exclusive OR calculating unit that calculates an exclusive OR of the second signal and the fourth signal.

Further, according to an embodiment of the present disclosure, there is provided an optical recording medium driving apparatus including an operation unit that calculates a sum of the exclusive OR calculated by the first exclusive OR calculating unit and the exclusive OR calculated by the second exclusive OR calculating unit.

The first and second exclusive OR calculating units and the operation unit operate in a state not synchronized with a channel clock.

The signal of “the sum of the exclusive OR of the first signal and the third signal and the exclusive OR of the second signal and the fourth signal” that is obtained by the operation unit has a minimum value at the time of tracing track centers and has amplitude increasing according to a detrack amount at the time of detracking (a direction is not considered), as will be described below (refer to a signal of <5> in FIG. 5). Specifically, the signal has a minimum value at the track centers and has a maximum value at a center point between the track centers. In terms of only a phase, the signal becomes a signal that has a deviation (advancement) of 90° with respect to an ideal tracking error signal and functions as a cross track signal.

The cross track signal that is generated as described above is appropriately generated in a reproduction dedicated optical recording medium in which tracks based on pit rows are formed.

According to the embodiments of the present disclosure described above, an appropriate cross track signal can be obtained to correspond to a reproduction dedicated optical recording medium.

### BRIEF DESCRIPTION OF THE DRAWINGS

FIG. 1 is a block diagram illustrating an internal configuration of an optical recording medium driving apparatus according to an embodiment;

FIG. 2 is a diagram illustrating a configuration of a light receiving unit that is included in the optical recording medium driving apparatus according to the embodiment;

FIG. 3 is a block diagram mainly illustrating a configuration of a tracking error signal generation system that is included in an optical recording medium driving apparatus according to a first embodiment;

FIGS. 4A and 4B are comparison diagrams of an operation (FIG. 4A) of an EXOR-type phase comparator according to the related art and an operation (FIG. 4B) of an EXOR circuit according to this embodiment;

FIG. 5 is a diagram illustrating an image of a waveform of each signal that is generated in this embodiment;

FIG. 6 is a block diagram illustrating a configuration to realize pulling control of a tracking servo using a cross track signal;

FIG. 7 is a block diagram mainly illustrating a configuration of a tracking error signal generation system that is included in an optical recording medium driving apparatus according to a second embodiment;

FIGS. 8A and 8B are flowcharts illustrating specific processing sequences to switch a delay time/operation clock; and

FIG. 9 is a diagram illustrating a mounting example in an asynchronous digital circuit.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.
<1. First Embodiment>
[1-1. Entire Configuration of Reproducing Apparatus]
[1-2. Configuration of Tracking Error Signal Generation System]
[1-3. Tracking Error Signal according to Embodiment]
[1-4. Use Method of Cross Track Signal]
<2. Second Embodiment>
<3. Modification>

### 1. First Embodiment

### [1-1. Entire Configuration of Reproducing Apparatus]

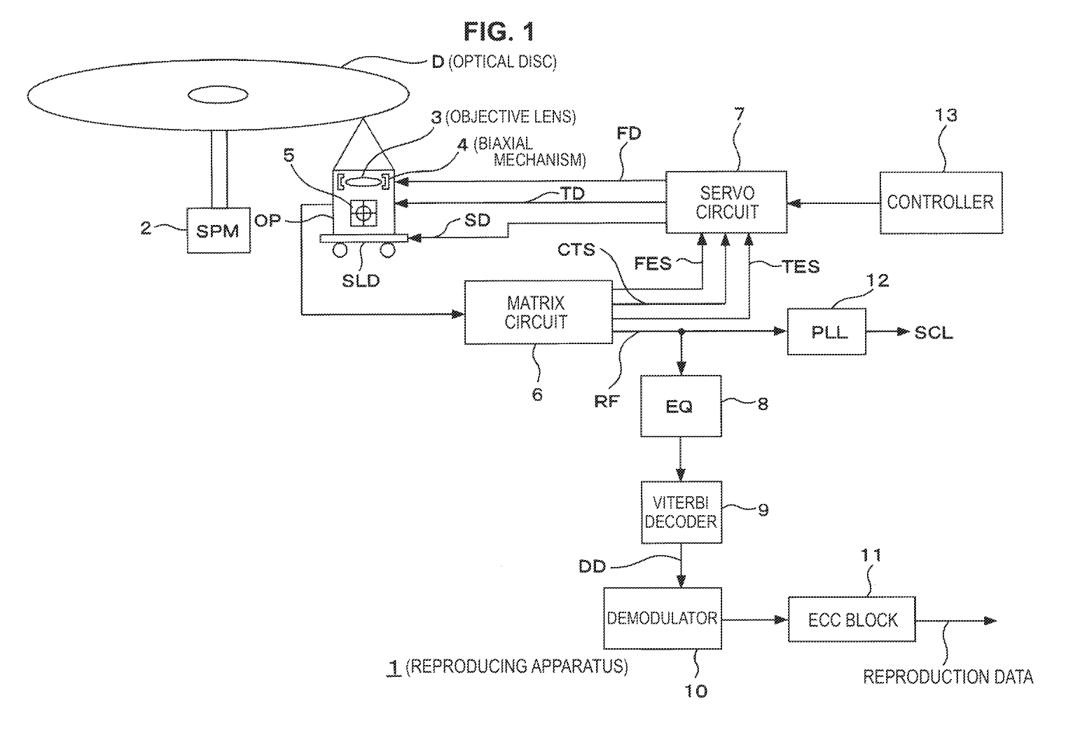

FIG. 1 is a block diagram illustrating an internal configuration of a reproducing apparatus 1 that is an embodiment of an optical recording medium driving apparatus of the present disclosure.

In FIG. 1, only a reproduction system and a servo system (a tracking servo and a focus servo) of the reproducing apparatus 1 with respect to a signal recorded on an optical disc D are illustrated and the other portions are omitted.

First, the optical disc D is driven to rotate according to a predetermined rotation driving method by a spindle motor (SPM) 2 illustrated in FIG. 1, in a state in which the optical disc D is mounted on a turntable (not illustrated in FIG. 1) provided in the reproducing apparatus 1. Rotation control of the spindle motor 2 is performed by a spindle servo circuit (not illustrated in the drawings).

In this case, as the optical disc D according to the embodiment, a reproduction dedicated ROM disc is assumed. Specifically, a high recording density disc such as a Blue-ray disc (BD: registered trademark) is used and reproduction is performed under conditions where an aperture ratio NA of an objective lens 3 to be described below is about 0.85 and a laser wavelength is about 405 nm.

An optical pickup device OP illustrated in FIG. 1 reads a record signal from the optical disc D that is driven to rotate by the spindle motor 2.

The optical pickup device OP includes a laser diode (not illustrated in FIG. 1) that becomes a laser light source, an objective lens 3 that condenses laser light from the laser diode to a recording surface of the optical disc D and radiates the laser light to the recording surface, and a four-division detector 5 that detects reflection light of the laser light from the optical disc D.

The optical pickup device OP further includes a biaxial mechanism 4 that holds the objective lens 3 in a tracking direction and a focus direction such that displacement is enabled. The biaxial mechanism 4 includes a tracking coil and a focus coil. In the biaxial mechanism 4, a tracking drive signal TD and a focus drive signal FD supplied from a servo circuit 7 to be described below are supplied to the tracking coil and the focus coil, so that the objective lens 3 is driven in the tracking direction and the focus direction.

In this case, the tracking direction is a short-side direction of tracks that are formed in the optical disc D. That is, the tracking direction is a direction that is orthogonal to a rotation direction (longitudinal direction of the tracks) of the optical disc D.

In addition, the focus direction is a direction that is toward and away from the optical disc D.

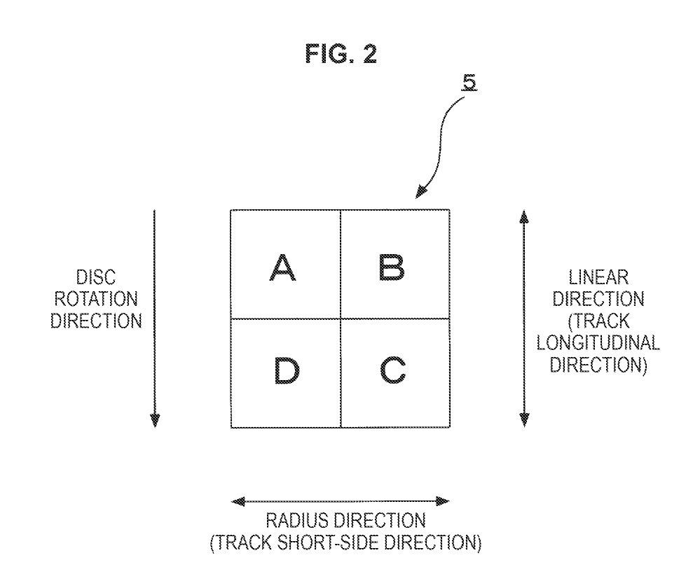

In this case, an arrangement of detectors (A, B, C, and D) in the four-division detector 5 in the optical pickup device OP will be described with reference to FIG. 2.

As illustrated in FIG. 2, a region of the four-division detector 5 is divided by a linear direction division line extending in a direction corresponding to a longitudinal direction of the tracks on the optical disc D and a tracking direction division line extending in a direction corresponding to a short-side direction (radius direction) of the tracks, such that the four detectors A, B, C, and D are formed.

Specifically, in the detectors A to D, a group of the detector A and the detector B and a group of the detector C and the detector D become groups that are segmented by the linear direction division line and a group of the detector A and the detector D and a group of the detector B and the detector C become groups that are segmented by the tracking direction division line.

In FIG. 2, a disc rotation direction is shown by a single arrow. However, if an upstream side and a downstream side are defined on the basis of a track (pit row) advancement direction according to a rotation of the optical disc D, the group of the detector A and the detector B becomes a group formed on the upstream side and the group of the detector C and the detector D becomes a group formed on the downstream side.

In this case, the upstream side means the side which the pit arrives at earlier.

Returning to FIG. 1 again, each light reception signal that is obtained by the four-division detector 5 is supplied to a matrix circuit 6. The matrix circuit 6 generates a reproduction signal RF, a tracking error signal TES, and a focus error signal FES based on each light reception signal. In this example, the matrix circuit 6 generates a cross track signal CTS.

A configuration of a generation system of the tracking error signal TES or the cross track signal in the matrix circuit 6 will be described in detail below.

The tracking error signal TES, the focus error signal FES, and the cross track signal CTS that are generated by the matrix circuit 6 are supplied to a servo circuit 7.

The servo circuit 7 executes a predetermined operation such as filtering to perform phase compensation or loop gain processing with respect to the tracking error signal FES and the focus error signal FES and generates a tracking servo signal TS and a focus servo signal FS. In addition, the servo circuit 7 generates a tracking drive signal TD and a focus drive signal FD on the basis of the tracking servo signal TS and the focus servo signal FS and supplies the tracking drive signal TD and the focus drive signal FD to the tracking coil/focus coil of the biaxial mechanism 4 in the optical pickup device OP.

In this case, the operation of the servo circuit 7 is performed and a tracking servo loop and a focus servo loop are formed by the four-division detector 5, the matrix circuit 6, the servo circuit 7, and the biaxial mechanism 4. The tracking servo loop and the focus servo loop are formed, so that a beam spot of laser light radiated to the optical disc D traces the tracks (pit rows) formed in the optical disc D and is maintained in an appropriate focus state.

The servo circuit 7 turns off the tracking servo loop according to a track jump instruction from a controller 13 to be described below, outputs a jump pulse as the tracking drive signal TD, and executes a track jump operation.

After the track jump, the servo circuit 7 turns on the tracking servo loop and performs pulling control to perform tracking servo control.

A configuration to pull the tracking servo in the servo circuit 7 will be described in detail below.

The servo circuit 7 generates a thread drive signal SD on the basis of access execution control by the controller 13 and drives a thread mechanism SLD illustrated in FIG. 1. Although not illustrated in detail in the drawing, the thread mechanism SLD includes a main shaft to hold the optical pickup device OP, a thread motor, and a transmission gear, drives the thread motor according to the thread drive signal SD, and performs a necessary slide movement of the optical pickup device OP.

The servo circuit 7 generates a thread error signal SE obtained as a low frequency component of the tracking error signal TES, generates and outputs a thread drive signal SD based on the thread error signal SE, and performs so-called thread servo control.

A phase locked loop (PLL) circuit 12 inputs a reproduction signal RF generated by the matrix circuit 6 and generates a system clock SCL from the reproduction signal RF. The system clock SCL that is generated by the PLL circuit 12 is supplied as an operation clock to each unit in which the system clock is necessary.

The reproduction signal RF that is generated by the matrix circuit 6 is branched and is also supplied to an equalizer (EQ) 8. The reproduction signal RF of which a waveform is shaped by the equalizer 8 is supplied to a Viterbi decoder 9.

Depending on the equalizer 8 and the Viterbi decoder 9, binarization processing using a bit detection method based on so-called partial response maximum likelihood (PRML) is executed. That is, the equalizer 8 executes waveform shaping processing such that the reproduction signal RF suitable for a PR class of the Viterbi decoder 9 is obtained. The Viterbi decoder 9 performs bit detection using a Viterbi detection method on the basis of the reproduction signal RF of which the waveform is shaped and obtains a reproduction data signal (binarization signal) DD.

The reproduction data signal DD that is obtained by the Viterbi decoder 9 is input to a demodulator 10. The demodulator 10 executes processing for detecting the reproduction data signal DD obtained as RLL (1, 7) PP (Parity preserve/prohibit, RLL: Run Length Limited) modulation data.

As such, RLL (1, 7) PP demodulated data is supplied to an ECC block 11 and is subjected to error correction processing or deinterleave processing. Thereby, reproduction data with respect to data that is recorded on the optical disc D is obtained.

The controller 13 is configured using a microcomputer that includes a central processing unit (CPU), a read only memory (ROM), and a random access memory (RAM). The controller 13 executes processing according to a program stored in a predetermined storage device such as the ROM and wholly controls the reproducing apparatus 1.

For example, the controller 13 outputs the track jump instruction described above and causes the servo circuit 7 to execute an operation for realizing the track jump operation. When data recorded at a predetermined address of the optical disc D is read, the controller 13 targets the predetermined address and executes seek operation control with respect to the servo circuit 7. That is, the controller 13 outputs an instruction to the servo circuit 8, targets the predetermined address, and executes a movement with respect to a beam spot formed by the optical pickup device OP.

### [1-2. Configuration of Tracking Error Signal Generation System]

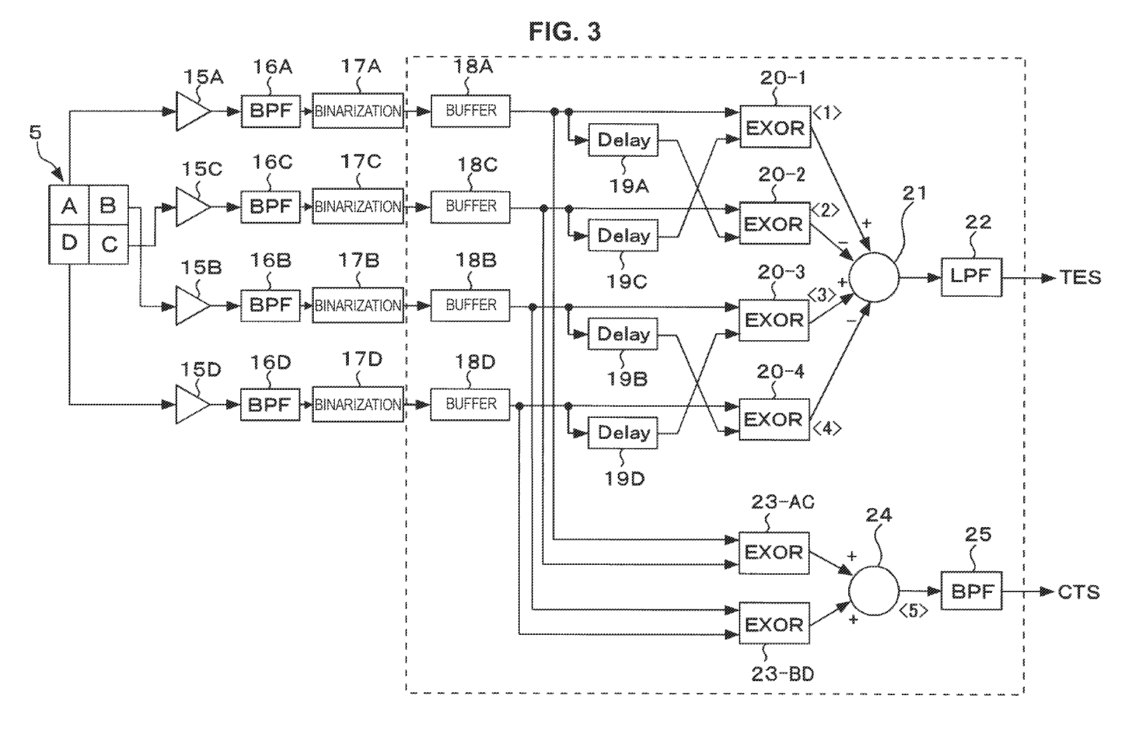

Next, a configuration of a generation system of the tracking error signal TES in the matrix circuit 6 illustrated in FIG. 1 will be described using the block diagram of FIG. 3.

FIG. 3 illustrates the four-division detector 5 illustrated in FIG. 1 and the generation system of the cross track signal CTS formed in the matrix circuit 6.

In the matrix circuit 6, the generation system of the tracking error signal TES includes I/V conversion amplifiers 15A to 15D, band-pass filters (BPFs) 16A to 16D, binarization circuits 17A to 17D, buffers 18A to 18D, delay circuits 19A to 19D, exclusive OR (EXOR) circuits 20-1 to 20-4, an operation unit 21, and a low-pass filter (LPF) 22, as illustrated in FIG. 3.

The generation system of the cross track signal CTS shares the I/V conversion amplifiers 15A to 15D, the BPFs 16A to 16D, the binarization circuits 17A to 17D, and the buffers 18A to 18D with the generation system of the tracking error signal TES. The generation system of the cross track signal CTS includes an EXOR circuit 23-AC, an EXOR circuit 23-BD, and a BPF 25.

In FIG. 3, a light reception signal of the detector A is input to the I/V conversion amplifier 15A. Likewise, light reception signals of the detector B, the detector C, and the detector D are input to the I/V conversion amplifier 15B, the I/V conversion amplifier 15C, and the I/V conversion amplifier 15D, respectively.

The I/V conversion amplifier 15 converts the input light reception signal into a voltage signal.

Output signals of the I/V conversion amplifier 15A, the I/V conversion amplifier 15B, the I/V conversion amplifier 15C, and the I/V conversion amplifier 15D are input to the BPF 16A, the BPF 16B, the BPF 16C, and the BPF 16D, respectively.

The BPF 16 attenuates a DC component included in the input signal and a noise component more than a reproduction signal frequency.

As will be described below, in this embodiment, because an input signal frequency more than an operation clock of a synchronization circuit block (to be described below) is allowed, an effect of an anti-aliasing filter is not necessary in the BPF 16.

As will be described below, according to a tracking error detection method according to the embodiment, because chattering tolerance can be enhanced, an EQ characteristic to increase amplitude of a short mark length signal to prevent chattering is not necessary.

Output signals of the BPF 16A, the BPF 16B, the BPF 16C, and the BPF 16D are input to the binarization circuit 17A, the binarization circuit 17B, the binarization circuit 17C, and the binarization circuit 17D, respectively.

The binarization circuit 17 includes a comparator and executes binarization processing with respect to the input signal.

In this embodiment, it is not necessary to use a hysteresis comparator to suppress the chattering in the comparator of the binarization circuit 17.

Hereinafter, a binarization signal that is obtained by the binarization circuit 17A is represented as a “signal A” and a binarization signal that is obtained by the binarization circuit 17B is represented as a “signal B”. Likewise, a binarization signal that is obtained by the binarization circuit 17C is represented as a “signal C” and a binarization signal that is obtained by the binarization circuit 17D is represented as a “signal D”.

In this case, a block that is surrounded with a broken line in FIG. 3 after the binarization circuit 17 becomes a synchronization circuit block that operates according to a common operation clock.

The signal A obtained by the binarization circuit 17A, the signal B obtained by the binarization circuit 17B, the signal C obtained by the binarization circuit 17C, and the signal D obtained by the binarization circuit 17D are input to the buffer 18A, the buffer 18B, the buffer 18C, and the buffer 18D, respectively. These signals are buffered by the buffers 18 and are synchronized.

The signal A that has passed through the buffer 18A is input to the EXOR circuit 20-1 and is also input to the EXOR circuit 20-2 through the delay circuit 19A.

The signal C that has passed through the buffer 18C is input to the EXOR circuit 20-2 and is also input to the EXOR circuit 20-1 through the delay circuit 19C.

That is, the non-delayed signal A and the delayed signal C are input to the EXOR circuit 20-1 and the delayed signal A and the non-delayed signal C are input to the EXOR circuit 20-2.

The signal B that has passed through the buffer 18B is input to the EXOR circuit 20-3 and is also input to the EXOR circuit 20-4 through the delay circuit 19B.

The signal D that has passed through the buffer 18D is input to the EXOR circuit 20-4 and is also input to the EXOR circuit 20-3 through the delay circuit 19D.

That is, the non-delayed signal B and the delayed signal D are input to the EXOR circuit 20-3 and the delayed signal B and the non-delayed signal D are input to the EXOR circuit 20-4.

The EXOR circuit 20-1 calculates an exclusive OR between the signal A input from the buffer 18A and the signal C input through the delay circuit 19C.

The EXOR circuit 20-2 calculates an exclusive OR between the signal A input through the buffer 19A and the signal C input from the buffer 18C.

The EXOR circuit 20-3 calculates an exclusive OR between the signal B input from the buffer 18B and the signal D input through the delay circuit 19D.

The EXOR circuit 20-4 calculates an exclusive OR between the signal B input through the delay circuit 19B and the signal D input from the buffer 18D.

Hereinafter, the exclusive OR that is calculated by the EXOR circuit 20-1 is represented as <1> and the exclusive OR that is calculated by the EXOR circuit 20-2 is represented as <2>.

The exclusive OR that is calculated by the EXOR circuit 20-3 is represented as <3> and the exclusive OR that is calculated by the EXOR circuit 20-4 is represented as <4>.

A signal of <1> obtained by the EXOR circuit 20-1, a signal <2> obtained by the EXOR circuit 20-2, a signal of <3> obtained by the EXOR circuit 20-3, and a signal of <4> obtained by the EXOR circuit 20-4 are input to the operation unit 21.

The operation unit 21 calculates “difference of a sum of <1> and <3> and a sum of <2> and <4>”, on the basis of the input signals. Specifically, the operation unit 21 calculates (<1>+<3>)−(<2>+<4>).

The signal that is calculated by the calculation executed by the operation unit 21 is output as the tracking error signal TES through the LPF 22.

In this example, the tracking error signal TES and the cross track signal CTS are generated.

Specifically, the cross track signal CTS is generated using outputs of the buffers 18A to 18D.

An output signal of the buffer 18A and an output signal of the buffer 18C are input to the EXOR circuit 23-AC and an output signal of the buffer 18C and an output signal of the buffer 18D are input to the EXOR circuit 23-BD.

The EXOR circuit 23-AC calculates an exclusive OR of the signal A input from the buffer 18A and the signal C input from the buffer 18C and the EXOR circuit 23-BD calculates an exclusive OR of the signal B input from the buffer 18B and the signal D input from the buffer 18D.

The exclusive OR obtained by the EXOR circuit 23-AC and the exclusive OR obtained by the EXOR circuit 23-BD are input to the operation unit 24.

The operation unit 24 calculates a sum of the exclusive OR obtained by the EXOR circuit 23-AC and the exclusive OR obtained by the EXOR circuit 23-BD.

The sum of the exclusive OR that is obtained by the operation unit 24 is output as the cross track signal CTS through the BPF 25.

Hereinafter, a sum signal (sum signal of the exclusive OR of the signal A and the signal C and the exclusive OR of the signal B and the signal D) that is calculated by the operation unit 24 is represented as <5>.

In this case, an operation clock in the tracking error signal generation system (and the cross track signal generation system) according to this embodiment will be described.

In this embodiment, as an operation clock of the tracking error signal generation system and the cross track signal generation system, a clock that is not synchronized with a channel clock is used. As a frequency of the operation clock, a frequency lower than a frequency of the channel clock can be set, as long as conditions to be described below are satisfied.

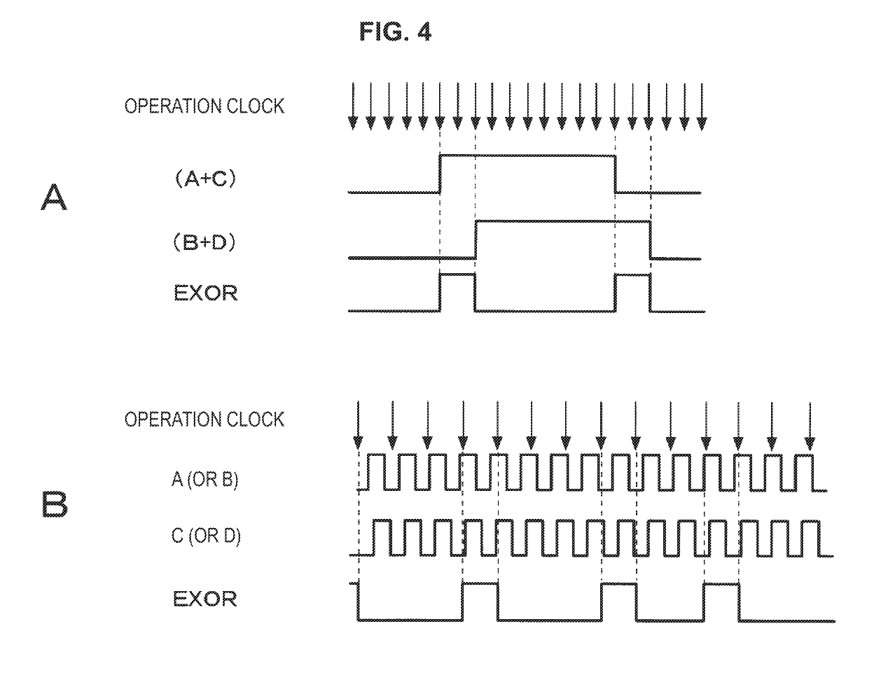

FIGS. 4A and 4B are comparison diagrams of an operation (FIG. 4A) of an EXOR-type phase comparator according to the related art and an operation (FIG. 4B) of an EXOR circuit according to this embodiment.

First, the EXOR-type phase comparator according to the related art illustrated in FIG. 4A operates with a relatively high frequency equal to the frequency of the channel clock and a phase difference of a signal (A+C) and a signal (B+D) is detected by the EXOR circuit.

In the phase comparator according to the related art, a signal having a so-called pulse width modulation (PWM) characteristic in which a pulse width changes according to an error amount from the track center is obtained as an output of the EXOR circuit.

Meanwhile, in this embodiment, as illustrated in FIG. 4B, the operation clock is not synchronized with the channel clock and the frequency of the operation clock is significantly lower than the frequency of the channel clock in this example.

FIG. 4B illustrates a relation of the operation clock of the synchronization circuit block (portion shown by a broken line) illustrated in FIG. 3, an example of waveforms of the signal A (or the signal B) and the signal C (or the signal D), and the exclusive OR (output signal of the EXOR circuit 23: delay performed by the delay circuit 19 is not considered).

Because phases of the two input signals are matched with each other when a beam spot is at the track center, an output of the EXOR circuit in this embodiment ideally becomes “0” (in actuality, the output does not become “0”, because an offset is generated due to the high recording density in the input signals, as will be described below). Meanwhile, because the phase difference is generated between the input signals when the beam spot deviates from the track center, the phase difference is detected at timing based on the operation clock and the output of the EXOR circuit becomes “1”. At this time, even if a non-synchronized operation clock is used, the probability of the phase difference between the input signals being detected becomes high when an error amount from the track center increases. As a result, the frequency of the output of the EXOR circuit becoming “1” increases when the error amount from the track center increases. In other words, the frequency of the output of the EXOR circuit becoming “0” increases when the error amount from the track center decreases.

As such, the phase comparator according to the related art shows the PWM characteristic. Meanwhile, in this embodiment, a signal having a so-called pulse density modulation (PDM) characteristic in which the pulse density changes according to the error amount from the track center is obtained.

[1-3. Tracking Error Signal according to Embodiment]

Hereinafter, the tracking error signal TES according to the embodiment will be described on the basis of the above-described premise.

First, the cross track signal CTS will be described for easy understanding of the tracking error signal TES according to the embodiment.

As can be understood from the above description, the cross track signal CTS becomes a signal that corresponds to a sum of the exclusive OR of the signal A input from the buffer 18A and the signal C input from the buffer 18C and the exclusive OR of the signal B input from the buffer 18B and the signal D input from the buffer 18D. In other words, the cross track signal CTS is a signal that corresponds to a sum of the exclusive OR of the non-delayed signal A and the non-delayed signal C and the exclusive OR of the non-delayed signal B and the non-delayed signal D.

In this case, the tracking error signal TES according to the embodiment is a signal that corresponds to the difference of the “sum of the exclusive OR of the non-delayed signal A and the delayed signal C and the exclusive OR of the non-delayed signal B and the delayed signal D” corresponding to “<1>+<3>” described above and the “sum of the exclusive OR of the delayed signal A and the non-delayed signal C and the exclusive OR of the delayed signal B and the non-delayed signal D” corresponding to “<2>+<4>”.

If the above point is considered, it can be known that the cross track signal CTS is obtained by excluding the delay with respect to each signal of “<1>+<3>” and “<2>+<4>” constituting the tracking error signal TES.

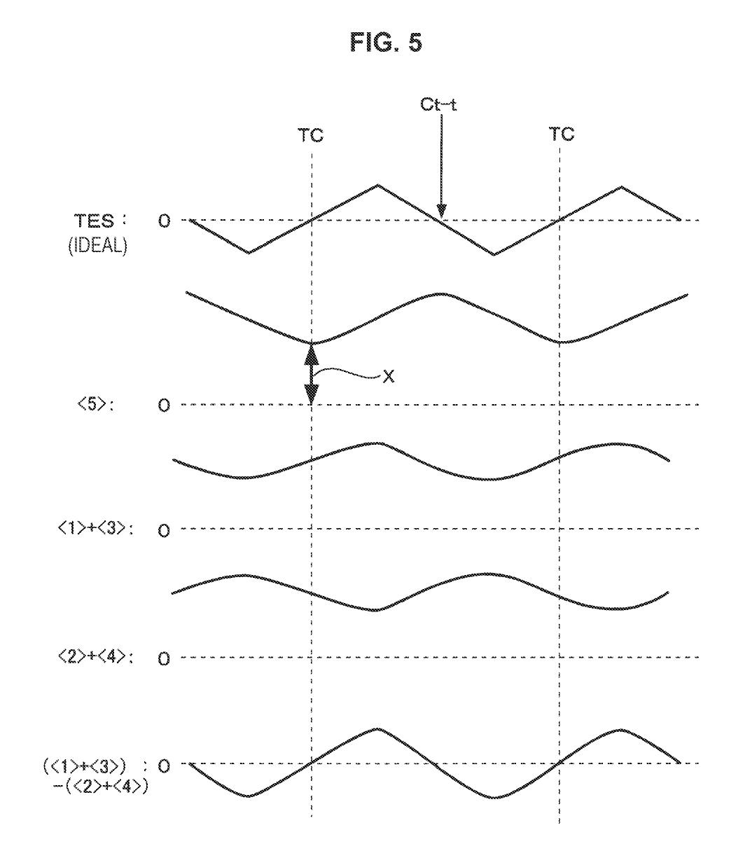

FIG. 5 illustrates an image of a waveform of each of signals generated in this embodiment, including the signal (<5>) of the “sum of the exclusive OR of the signals A and C and the exclusive OR of the signals B and D” that corresponds to the cross track signal CTS.

Specifically, FIG. 5 illustrates images of a waveform (ideal waveform) of the tracking error signal TES, a waveform of the signal of <5>, a waveform of the signal of “<1>+<3>”, a waveform of the signal of “<2>+<4>”, and a waveform of the signal of (<1>+<3>)−(<2>+<4>), sequentially from an upper stage, with respect to the signal waveforms obtained when the beam spot is moved in a radius direction of the optical disc D.

With respect to the waveforms of the signals of <5>, “<1>+<3>”, “<2>+<4>”, and (<1>+<3>)−(<2>+<4>), averaged waveforms are illustrated in FIG. 5.

First, as a premise, the ideal tracking error signal TES becomes a signal of which an amplitude level oscillates positively/negatively in a direction away from the track center (represented as TC in FIG. 5) as the amplitude level is away from the track center, as illustrated at the uppermost stage of FIG. 5. At this time, the tracking error signal TES zero-crosses at a center point (represented as Ct-t in FIG. 5) between the track centers TC. In this case, ideally, the zero-cross at the track center TC becomes the cross of negative→positive and the zero-cross at the center point Ct-t becomes the cross of positive→negative.

The signal of <5> that corresponds to the cross track signal CTS takes a minimum value at the track center TC and a maximum value at the center point Ct-t and amplitude thereof increases as the error amount from the track center TC increases, as illustrated in FIG. 5.

In terms of only a phase, the phase of the signal of <5> is deviated by 90° (advanced by 90°), with respect to the tracking error signal TES.

In this case, with regard to the signal of <5>, attention is paid to the track center TC. When ideal binarization signals (signals A, B, C, and D) in which there is no influence of deterioration due to the high recording density are obtained, the binarization signals become the same signals at the track center TC. For this reason, an amplitude level becomes “0”. However, in actuality, the amplitude level of the signal of <5> does not completely become “0” at the track center TC, due to an influence of the deterioration of the binarization signals such as the chattering, the pulse width variation, and the local signal omission and a DC offset shown by “X” in FIG. 5 is generated.

A level of the offset X increases or decreases according to a deterioration degree of the binarization signal.

A bottom portion of the signal of <5> becomes a gradual U-shaped pattern due to the influence of the deterioration of the binarization signal and the influence of the phase difference of the signals of A+C and B+D. For this reason, even if a method of calculating a minimum level of the signal of <5> is adopted, the track center TC may not be detected with high precision. In other words, it is difficult to perform appropriate tracking error detection in the cross track signal CTS.

In order to obtain the ideal tracking error signal TES, the phase of the signal of <5> may be delayed by 90° and the offset X may be removed.

For this reason, in this embodiment, with respect to the signals A and C and the signal B and D constituting the signal of <5>, a signal of “<1>+<3>” obtained by delaying the signals C and D and a signal of “<2>+<4>” obtained by delaying the signals A and B are generated and (<1>+<3>)−(<2>+<4>) to be a difference of the signals is calculated.

As can be known from FIG. 2 described above, the signals C and D are the signal obtained from the detectors of the downstream side and the signals A and B are the signals obtained from the detectors of the upstream side.

If the above point is considered, it can be known that the signal of “<1>+<3>” becomes a signal obtained by delaying the signals C and D of the downstream side and the signal of “<2>+<4>” becomes a signal obtained by delaying the signals A and B of the upstream side, with regard to the signal of <5>.

If the signals of the downstream side constituting the signal of <5> are delayed, the phases thereof can be delayed by the amount according to the delay time. Meanwhile, if the signals of the upstream side are delayed, the phases thereof can be advanced by the amount according to the delay time.

By appropriately setting the delay time at that time, a signal that is obtained by delaying the phase of the signal of <5> by 90° can be obtained as the signal of “<1>+<3>”. Meanwhile, a signal that is obtained by advancing the phase of the signal of <5> by 90° can be obtained as the signal of “<2>+<4>”. In other words, a signal of which a phase is matched with a phase of the ideal tracking error signal TES can be obtained as the signal of “<1>+<3>” and a signal of which a phase is opposite to the phase of the ideal tracking error signal TES can be obtained as the signal of “<2>+<4>”.

As described above, in this embodiment, (<1>+<3>)−(<2>+<4>) is calculated as the difference of “<1>+<3>” and “<2>+<4>”. As the signal of (<1>+<3>)−(<2>+<4>), a signal of which a phase is matched with the phase of the ideal tracking error signal TES and from which the DC offset X is removed can be obtained, as illustrated in FIG. 5. As a result, almost the same signal as the ideal tracking error signal TES can be obtained.

In this case, when the tracking error detection method is realized, a delay amount (delay time) in each delay circuit 19 becomes important. The delay amount may be set as follows.

That is, the delay amount may be basically set to a “half time of a signal deviation time generated at the track center TC and the center point Ct-t”. By setting the delay amount, the phase deviation of 90° can be realized.

However, it is preferable to make the delay amount small depending on the deterioration degree of the binarization signal. Specifically, it is recognized from experience that, if the delay amount is made to be small, the DC offset of the signals of “<1>+<3>” and “<2>+<4>” decreases and AC amplitude increases.

Therefore, if the above point is considered, it is preferable to set the delay amount to be slightly shorter than the “half time of the signal deviation time generated at the track center TC and the center point Ct-t”.

In actuality, after an operation is confirmed, even when the delay amount changes from the delay amount corresponding to the “half time of the signal deviation time generated at the track center TC and the center point Ct-t” by about ±3 dB, the amplitude of the tracking error signal TES is not attenuated greatly by the amount corresponding to the delay amount. As a measurement result of the tracking error signal TES in a state in which the delay amount is doubled or is reduced to ½, the amplitude is attenuated greatly. However, even in this state, it has been confirmed that a zero-cross portion of the tracking error signal TES corresponds to the track center TC.

For confirmation, the “half time of the signal deviation time generated at the track center TC and the center point Ct-t” will be supplemented.

First, as a premise, when the beam spot is at the center point Ct-t between the track centers TC, the phase difference of the signal (A+C) and the signal (B+D) is maximized. At this time, the phase difference is defined as a maximum phase difference Δmax.

The maximum phase difference Δmax can be calculated from optical conditions such as a track pitch and a spot size and a rotation speed (line speed) and a line density of the optical disc D (for example, refer to Japanese Patent Application Laid-Open No. H7-296395).

The “half time of the signal deviation time generated at the track center TC and the center point Ct-t” means a time that corresponds to ½ of the maximum phase difference Δmax.

For example, in the case of the BD, the track pitch is about 320 nm. Therefore, the distance between the track center TC and the center point Ct-t is about 160 nm. If the signal phase difference (signal deviation time) of the signal (A+C) and the signal (B+D) generated to correspond to the tracking error of 160 nm can be known, the half time approximately becomes the delay time to be set.

If it is assumed that the maximum phase difference Δmax is about 2 T, the delay time may be set to about 1 T to be half.

In this embodiment, the delay circuit 18 operates according to the operation clock described above. In this case, as conditions of the operation clock, the operation clock should be not synchronized with the channel clock as described above and the delay amount based on the “half time of the signal deviation time generated at the track center TC and the center point Ct-t” should be realized.

Meanwhile, as can be understood from the above description, in this embodiment, a signal that has the PDM characteristic is obtained as (<1>+<3>)−(<2>+<4>) calculated by the operation unit 21.

Executing the appropriate LPF processing with respect to the signal having the PDM characteristic by the LPF 22 illustrated in FIG. 3 becomes important in improving the tracking error detection precision.

In this case, the LPF 22 is provided so that an integral effect with respect to the phase relation information extracted in a PDM manner as described above can be obtained. As a result, an influence on the tracking error signal TES by the error of each pulse can be decreased, which results in contributing to accurate tracking error detection.

A band of the LPF 22 should be set to be lower than a band having an anti-aliasing effect, with respect to the operation clock of a rear-step block (servo circuit 7) to perform servo control in actuality.

At this time, the LPF band is set to be lower in a range in which the necessary servo band is obtained, so that the integral effect is improved and a high-quality tracking error signal TES can be obtained.

Because the LPF 22 accurately reflect all information of the input signal to a signal after the LPF processing, it is preferable to mount the LPF 22 in consideration of bit precision, such that an influence of rounding error decreases. In actuality, according to the result obtained by performing operation confirmation under conditions of 2X (channel clock of 132 MHz) of the BD and operation clock=50 MHz described above, a superior tracking error signal TES has been obtained by using an LPF of a bit shift type using a 32-bit register of which mounting is simple, as the LPF 22.

As described above, according to the tracking error detection method according to this embodiment, even when the pulse width variation or the chattering is generated due to the high recording density of the optical disc D, an influence thereof appears as a signal offset (the offset X of the signal of the sum of <1> and <3> and the signal of the sum of <2> and <4>) and is offset as described above in the course of generating the tracking error signal TES. For this reason, the tracking error detection precision can be prevented from being deteriorated due to the pulse width variation or the chattering.

As a result, the previous problem of the phase detection error pointed out as [a][b] can be effectively prevented from occurring. In other words, tracking error detection can be stably performed from the light reception signal deteriorated due to the high recording density.

According to this embodiment, because the high-speed operation at the same level as a channel clock is not necessary, the previous problem of [c] relating to rising of the reproduction signal frequency can be prevented.

With respect to the problem of [d] occurred when the phase difference is generated in each of the signal A, the signal B, the signal C, and the signal D by the pit depth, in this embodiment, the signal A and the signal C are not added and the signal B and the signal D are not added, a phase relation (EXOR) of the signal A and the signal C and a phase relation (EXOR) of the signal B and the signal D are detected, and the tracking error is detected using detection information. Thereby, even though the phase difference due to the pit depth is generated in the signal A and the signal B and the signal C and the signal D, the tracking error can be appropriately detected.

In this case, with respect to the cross track signal CTS, similarly, the signal A and the signal C are not added and the signal B and the signal D are not added, a phase relation (EXOR) of the signal A and the signal C and a phase relation (EXOR) of the signal B and the signal D are detected, and the signal is generated. Therefore, the signal error can be prevented from being generated due to the pit depth.

In a differential phase detection (DPD) circuit, a digital phase shifter may be used. The phase shifter shifts a phase according to a frequency of an input signal. In order to realize the phase shift, it is necessary to accurately detect a period of the input signal. In the high-density optical disc, because the phenomena such as the chattering, the pulse width variation, and the local pulse omission are generated frequently, the frequency of an erroneous operation of the phase shifter may increase.

Meanwhile, in this embodiment, processing similar to processing of the phase shift is executed in generation of the signal of “<1> and <3>” or “<2> and <4>”. However, the processing is realized by the delay circuit 18.

Therefore, in this embodiment, because it is not necessary to use the phase shifter, the problem relating to the phase shifter does not occur.

As described above, the delay time in this embodiment is determined under various conditions such as a laser spot diameter, a track pitch, a line density, and a double speed. For this reason, as in the case of using the phase shifter, dynamic control according to the input signal is not necessary.

In a recent DPD circuit, the signals A to D are converted into digital data by a multi-bit A/D converter (ADC) and processing is executed.

In this method, in a general optical disc drive control LSI (integrated circuit), it is necessary to mount two to fourth high-speed ADCs having the same performance as only one high-speed ADC used for a read channel to be exclusively used for generation of a tracking signal, which results in increasing a chip area of the LSI, consumption power, and a manufacturing cost.

Meanwhile, in this embodiment, because it is not necessary to convert the signals A to D into digital data by the ADC, the above problem can be prevented from occurring.

In addition, there is a DPD method using an analog auto gain control (AGC) amplifier to match amplitudes of the signals A to D, such as using a phase comparator of a multiplier type.

In addition, there is a method using two to four peak/bottom hold circuits to detect a level of an input signal to appropriately set a hysteresis level at all times, when a hysteresis comparator is introduced to suppress the chattering of the binarization signal.

An analog circuit that is used in the above method occupies a large area in an optical disc LSI chip in which shrink advances and has relatively large consumption power. To operate the analog circuit with high precision at a high double speed causes a degree of difficulty of a design to increase.

Meanwhile, in this embodiment, because the analog AGC amplifier or the hysteresis comparator is not necessary, the problem can be prevented from occurring.

### [1-4. Use Method of Cross Track Signal]

Next, a use method of a cross track signal CTS will be described.

As can be understood from the above description, the cross track signal generation method according to this embodiment can obtain an appropriate signal to enable distinguishing of a zero-cross point corresponding to the track center TC and a zero-cross point corresponding to the center point Ct-t between the track centers, when the pit rows are formed in the optical disc.

As described above, as zero-cross points of the tracking error signal TES, there are two zero-cross points for each period. Of the two zero-cross points, one zero-cross point (a zero-cross point of negative→positive in the example of FIG. 5) showing the actual track center TC enables a tracking servo to be stably applied.

However, when a direction in which the beam spot crosses the track is unclear, it may not be determined which zero-cross point shows the true track center TC, by using only the tracking error signal TES.

As can be known with reference to FIG. 5 described above, the cross track signal CTS is a signal of which amplitude is minimized at only the track center TC. If this property is used, it can be determined which zero-cross point shows the true track center TC, by using the cross track signal CTS.

Specifically, in this example, the cross track signal CTS is binarized, it is determined that the zero-cross point obtained in the tracking error signal TES shows the true track center CT in a section in which the binarized cross track signal CTS is “0”, and it is determined that the zero-cross point obtained in the tracking error signal TES does not show the true track center TC in a section in which the binarized cross track signal CTS is “1”.

In this example, the case in which the above determination processing is executed to correspond to when the tracking servo is pulled is exemplified.

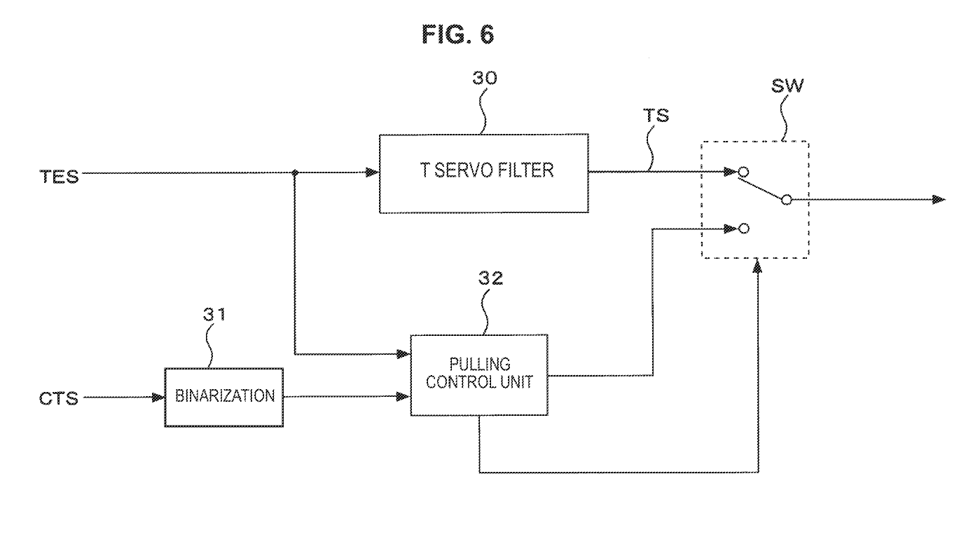

FIG. 6 is a block diagram illustrating a configuration to realize pulling control of the tracking servo using the cross track signal CTS.

First, the tracking error signal TES that is output from the LPF 22 illustrated in FIG. 3 described above is input to a T servo filter 30 (T is an abbreviation of tracking) that is provided in the servo circuit 7. The T servo filter 30 executes filtering for the above-described phase compensation or the loop gain processing and generates a tracking servo signal TS. As illustrated in FIG. 6, the tracking servo signal is input to a switch SW.

The tracking error signal TES is also input to a pulling control unit 32 illustrated in FIG. 6.

The cross track signal CTS from the BPF 25 illustrated in FIG. 3 is binarized by a binarization circuit 31 and is input to the pulling control unit 32.

The pulling control unit 32 realizes pulling of the tracking servo by switching of the switch SW.

In this case, the pulling control unit 32 performs an output of a jump pulse for the track jump or an output of a brake pulse. The output pulses are input to the switch SW.

The pulling control unit 32 performs pulling control on the basis of the tracking error signal TES and the binarized cross track signal CTS. Specifically, the pulling control unit 32 monitors the amplitude of the tracking error signal TES and the binarized cross track signal CTS. When conditions where the zero-cross of the tracking error signal TES is generated and a level of the binarized cross track signal CTS is “0” (Low level) are satisfied, the pulling control unit 32 causes the switch SW to select the tracking servo signal TS. In other words, when it is determined that the zero-cross of the tracking error signal TES corresponding to the center point Ct-t between the track centers is generated and the beam spot position is near the track center TC, the pulling control unit 32 executes pulling of the tracking servo.

By this configuration, stable pulling of the tracking servo is enabled.

In this case, the control described above is performed as pulling of the tracking servo after performing long-distance seek to drive the optical pickup device OP by the thread mechanism SLD or pulling of the tracking servo after the focus servo is pulled.

The cross track signal CTS can be appropriately used in the brake control at the time of the track jump. Specifically, at the time of the brake control, it is preferable to determine the movement direction of the beam spot to realize an accurate (stable) jump operation. The cross track signal CTS can be appropriately used as a signal to determine the movement direction of the beam spot at the time of the brake control.

As can be understood from the above description, the cross track signal CTS used in this example may be obtained by a condition of crossing the track, when the tracking servo is pulled or the track jump operation is executed.

In view of the above point, with respect to the signal of <5> output by the operation unit 24, a DC component (offset X) may be cut by the BPF 25.

If necessary, instead of the BPF 25, an offset subtraction circuit can be provided and a cross track signal CTS in which a DC component (offset X) is maintained can be generated.

### 2. Second Embodiment

As can be understood from the above description, with respect to the delay times to be given to the signals A to D in the embodiment, the time lengths should be set according to the track pitch, the spot size, the rotation speed (line speed) of the optical disc D, and the line density.

In view of the above point, the delay time is preferably set variably according to the line density, for each medium type (for example, BD/DVD/CD) of the optical disc D or in the same medium type.

Therefore, in this embodiment, a configuration in which the delay time is set variably is suggested.

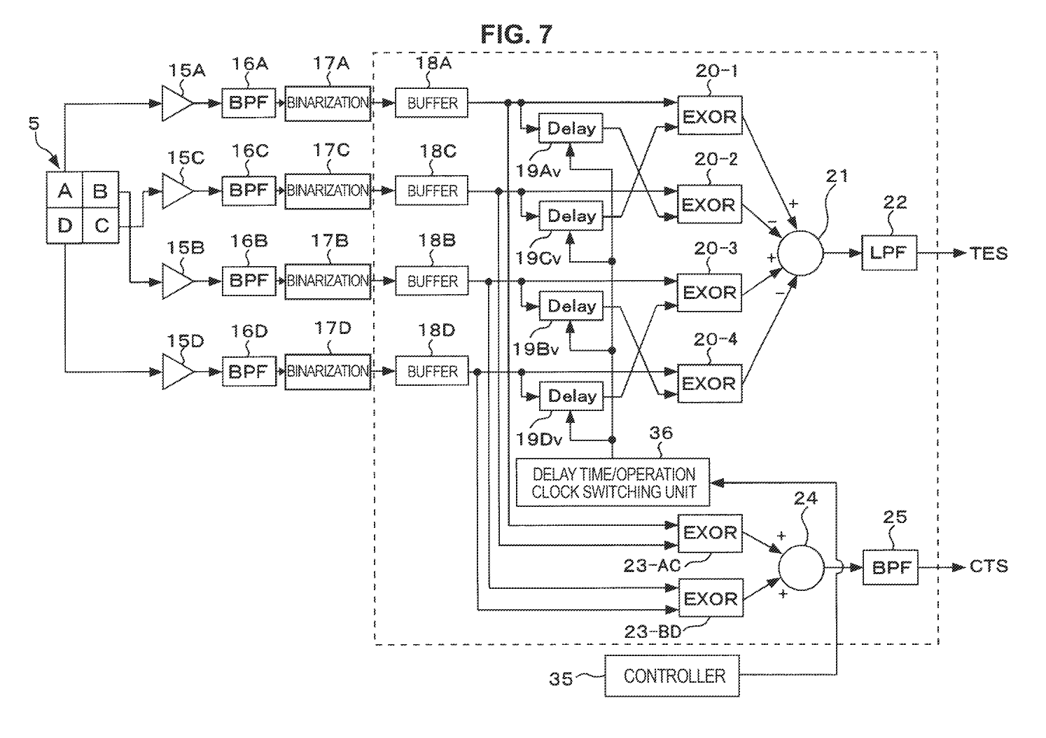

FIG. 7 is a block diagram mainly illustrating a configuration of a tracking error signal generation system (including a cross track signal generation system) according to the second embodiment.

In FIG. 7, the same portions as the portions described above are denoted by the same reference numerals and explanation thereof is omitted.

Even in this case, an entire configuration (except for a controller 13) of a reproducing apparatus is the same as that illustrated in FIG. 1.

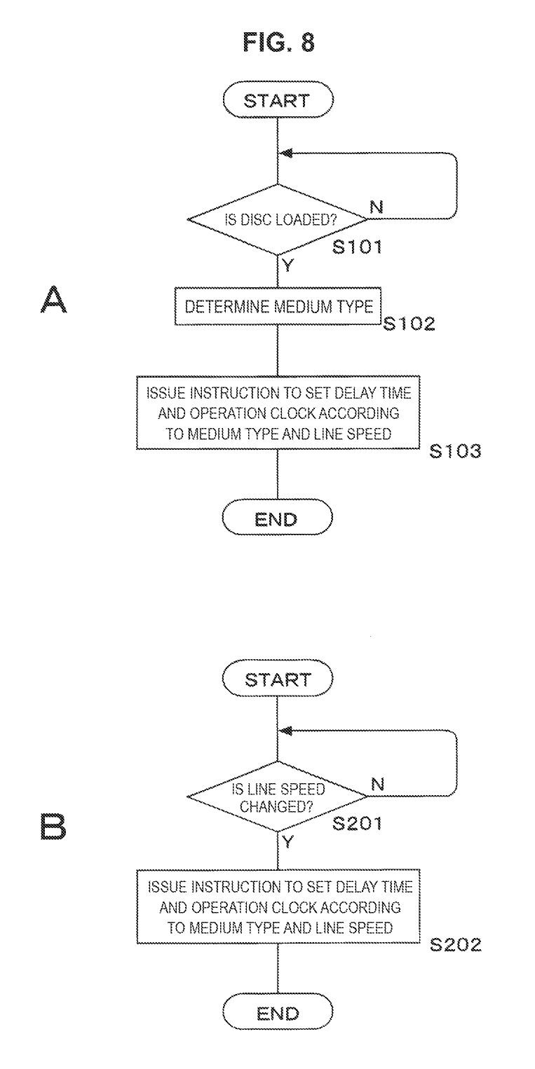

As can be known from a comparison with FIG. 3 described above, the configuration of the tracking error signal generation system according to the second embodiment is different from the configuration of the tracking error signal generation system according to the first embodiment in that delay circuits 19Av, 19Bv, 19Cv, and 19Dv having variable delay times are provided, instead of the delay circuits 19A, 19B, 19C, and 19D, and a delay time/operation clock switching unit 36 is added. In this case, instead of the controller 13, a controller 35 to execute processing illustrated in FIG. 8 to be described below is provided.

In this example, the delay time/operation clock switching unit 36 switches the delay time and the operation clock (operation clock of a synchronization circuit block shown by a broken line).

To adopt a method of setting an operation clock based on a frequency corresponding to the fastest double speed enabled in the reproducing apparatus with respect to the operation clock is also considered. However, it is preferable to set the operation clock according to the double speed, because the consumption power of the digital circuit may be optimized. In this example, the operation clock is switched in consideration of the above point.

The delay time/operation clock switching unit 36 sets the delay times of the delay circuits 19Av, 19Bv, 19Cv, and 19Dv and the operation clock, according to an instruction from the controller 35.

Specific processing sequences to switch the delay times and the operation clock by the controller 35 will be described on the basis of flowcharts illustrated in FIGS. 8A and 8B.

FIG. 8A illustrates an example of a processing sequence to be executed according to loading of the optical disc D and FIG. 8B illustrates an example of a processing sequence to be executed to correspond to when the line speed is changed after loading of the optical disc D.

In FIG. 8A, in step S101, the controller 35 maintains a waiting state until the optical disc D is loaded. When the optical disc D is loaded, in step S102, the controller 35 determines a medium type of the optical disc D. The determination of the medium type can be performed on the basis of the measured result of the reflectance of the optical disc. Alternatively, the determination of the medium type can be performed by reading identification information of the medium type recorded on the optical disc D.

After the medium type is determined in step S102, in step S103, the controller 35 instructs the delay time/operation clock switching unit 36 to set the delay time/operation clock according to the medium type and the line speed.

In this case, with respect to the delay time and the operation clock frequency according to the medium type and the line speed, a conversion table showing a correspondence relation thereof is prepared and the delay time and the operation clock frequency are set by referring to the conversion table.

As the conversion table, the delay time becoming about the “half time of the signal deviation time generated at the track center TC and the center point Ct-t” and the operation clock frequency realizing the delay time are calculated for each combination of assumed medium types and line speeds and information in which the delay times and the operation clock frequencies are associated is stored in a memory readable by the controller 35.

The controller 35 reads corresponding information of the delay time and the operation clock frequency from the conversion table, on the basis of the information of the medium type determined in step S102 and the information of the double speed (line speed) at the time of the reproduction operation and instructs the delay time/operation clock switching unit 36 to set the delay time and the operation clock frequency.

According to the instruction of step S103, the delay time/operation clock switching unit 36 sets the delay time according to the medium type and the line speed to the delay circuits 19Av, 19Bv, 19Cv, and 19Dv and sets the operation clock according to the medium type and the line speed.

Next, in FIG. 8B, in step S201, the controller 35 maintains a waiting state until the line speed is changed. When the line speed is changed, in step S202, the controller 35 instructs the delay time/operation clock switching unit 36 to set the delay time/operation clock according to the medium type and the line speed, similar to step S103 described above.

In this case, the medium type is already determined according to the loading of the optical disc D by step S102 of FIG. 8A described above.

When a constant angular velocity (CAV) method is adopted as a rotation control method of the optical disc D (when a disc according to a CLU format is reproduced according to the CAV method), the line speed changes every moment after the reproduction start. In this case, the processing illustrated in FIG. 8 becomes particularly effective.

### 3. Modification

The embodiments of the present disclosure have been described. However, the present disclosure is not limited to the specific examples described above.

For example, in the above description, the configuration in which the individual units (the buffer 18, the delay circuit 19, and the EXOR circuits 20 and 23) relating to the operation of the tracking error signal TES (and the cross track signal CTS) are operated by the same operation clock, that is, synchronously operated is exemplified. However, the individual units relating to the signal operation can be asynchronously operated.

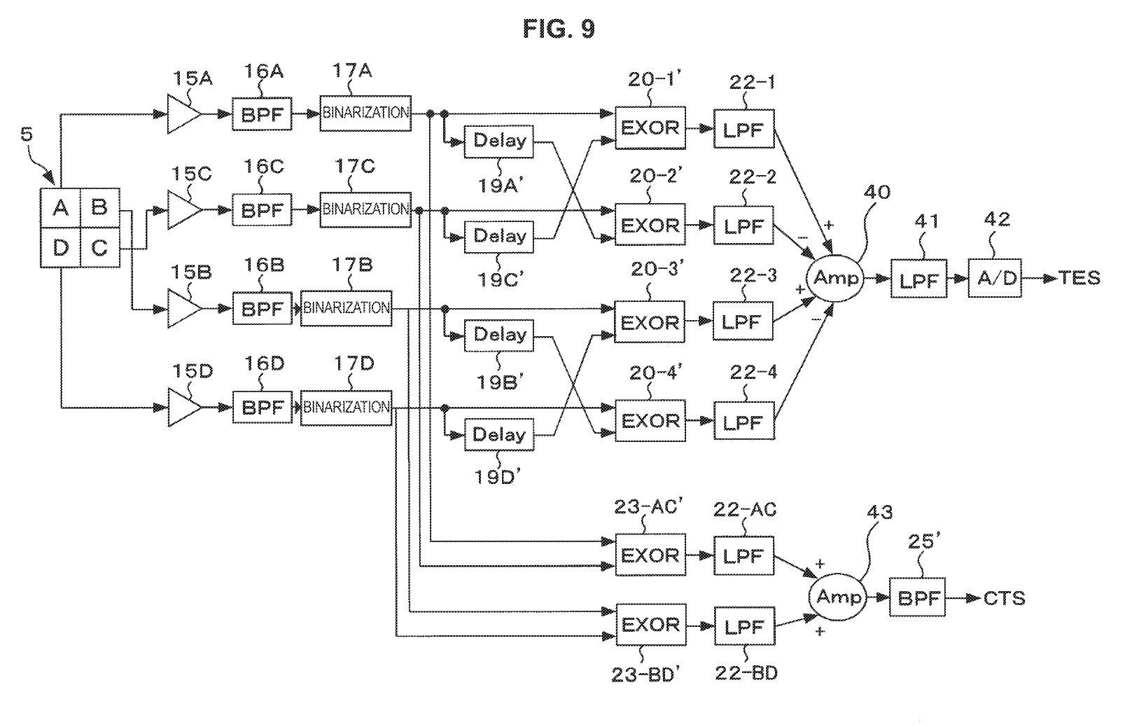

FIG. 9 is a diagram illustrating a mounting example in an asynchronous digital circuit.

In the example of FIG. 9, the configuration of the operation system of the tracking error signal TES according to the embodiment is realized by a combination of an asynchronous digital circuit and an analog circuit.

In this case, the buffers 18 for the synchronization are omitted and a signal A is input to an EXOR circuit 20-1′ and a delay circuit 19A′, a signal C is input to an EXOR circuit 20-2′ and a delay circuit 19C′, a signal B is input to an EXOR circuit 20-3′ and a delay circuit 19B′, and a signal D is input to an EXOR circuit 20-4′ and a delay circuit 19D′.

An output of the delay circuit 19A′ is input to the EXOR circuit 20-2′, an output of the delay circuit 19C′ is input to the EXOR circuit 20-1′, an output of the delay circuit 19B′ is input to the EXOR circuit 20-4′, and an output of the delay circuit 19D′ is input to the EXOR circuit 20-3′.

In the generation system of the cross track signal CTS, the signals A and C are input to the EXOR circuit 23-AC′ and the signals B and D are input to the EXOR circuit 23-BD′.

In this case, each of the EXOR circuits 20-1′, 20-2′, 20-3′, 20-4′, 23-AC′, and 23-BD′ outputs an exclusive OR of input signals. However, the EXOR circuits 20-1′, 20-2′, 20-3′, 20-4′, 23-AC′, and 23-BD′ are different from the EXOR circuits illustrated in FIGS. 3 and 7 in that the EXOR circuits 20-1′, 20-2′, 20-3′, 20-4′, 23-AC′, and 23-BD′ are not operated with an operation clock common to the other portions. The delay circuits 19A′, 19B′, 19C′, and 19D′ apply the delay of the predetermined amount to the input signals and output the input signals, similar to the delay circuits 19A, 19B, 19C, and 19D. However, the delay circuits 19A′, 19B′, 19C′, and 19D′ are different from the delay circuits 19A, 19B, 19C, and 19D in that the delay circuits 19A′, 19B′, 19C′, and 19D′ are not operated with an operation clock common to the other portions.

In this case, outputs of the EXOR circuits 20-1′, 20-2′, 20-3′, and 20-4′ are input to the LPFs 22-1, 22-2, 22-3, and 22-4, respectively, as illustrated in FIG. 9.

The LPFs 22-1 to 22-4 execute the same LPF processing as the LPF 22 described above and smooth the input signals.

Outputs of the LPFs 22-1 to 22-4 are added/subtracted by an amplifier 40. Specifically, if an output of the LPF 22-1, an output of the LPF 22-2, an output of the LPF 22-3, and an output of the LPF 22-4 are defined as <1>′, <2>′, <3>′, and <4>′, respectively, (<1>′+<3>′)−(<2>′+<4>′) is calculated to obtain a difference of “<1>′+<3>′” and “<2>′+<4>′”.

An output of the amplifier 40 is subjected to LPF processing having considered anti-aliasing for A/D conversion of a rear step in an LPF 41, is subjected to A/D conversion by an A/D converter 42, and is output as a tracking error signal TES.

At an operation side of a cross track signal CTS, an output of the EXOR circuit 23-AC′ is input to the LPF 22-AC and an output of the EXOR circuit 23-BD′ is input to the LPF 22-BD and the outputs are smoothened by the same LPF processing as the LPF 22 described above.

The outputs of the LPF 22-AC and the LPF 22-BD are added by an amplifier 43, are subjected to the same filter processing (the removal of the DC component) as the above-described BPF 25 in the BPF 25′, and is output as a cross track signal CTS.

The cross track signal CTS may be binarized by the binarization circuit 31, in the use method described in FIG. 6.

According to advantages of the configuration illustrated in FIG. 9, the circuit configuration for synchronization such as the buffer 18 is not necessary, the mounting type of the DPD circuit is similar to the mounting type of the DPD circuit according to the related art, and the configuration is suitable for the case in which the tracking error signal TES (and the cross track signal CTS) is generated with a circuit common to the optical disc D having the relatively low recording density.

In the above description, the present disclosure is applied to the reproducing apparatus in which only reproduction with respect to the optical disc D is enabled. However, the present disclosure can be appropriately applied to a recording/reproducing apparatus in which both reproduction and recording with respect to the optical disc D are enabled.

It should be understood by those skilled in the art that various modifications, combinations, sub-combinations and alterations may occur depending on design requirements and other factors insofar as they are in the scope of the appended claims or the equivalents thereof.

Additionally, the present technology may also be configured as below.

(1) An optical recording medium driving apparatus including:

a light radiating unit that radiates light to an optical recording medium;

a light receiving unit that receives reflection light from the optical recording medium, in which four regions including a first region, a second region, a third region, and a fourth region are formed by being divided by a linear direction division line extending in a direction corresponding to a longitudinal direction of a track formed in the optical recording medium and a tracking direction division line extending in a direction corresponding to a short-side direction of the track, the first region and the second region, and the third region and the fourth region being segmented by the linear direction division line, the first region and the fourth region, and the second region and the third region being segmented by the tracking direction division line, the first region and the second region being arranged on an upstream side based on an advancement direction of the track, and the third region and the fourth region being arranged on a downstream side based on the advancement direction of the track;

a first binarizing unit that obtains binarization signals based on light reception signals obtained in the respective first to fourth regions in the light receiving unit as a first signal, a second signal, a third signal, and a fourth signal, respectively;

a first exclusive OR calculating unit that calculates an exclusive OR of the first signal and the third signal;

a second exclusive OR calculating unit that calculates an exclusive OR of the second signal and the fourth signal; and

an operation unit that calculates a sum of the exclusive OR calculated by the first exclusive OR calculating unit and the exclusive OR calculated by the second exclusive OR calculating unit,

wherein the first and second exclusive OR calculating units and the operation unit operate in a state not synchronized with a channel clock.

(2) The optical recording medium driving apparatus according to (1), further including:

a DC removing unit that removes a DC component of a signal as the sum of the exclusive OR obtained by the operation unit.

(3) The optical recording medium driving apparatus according to (1) or (2), further including:

a second binarizing unit that binarizes a signal as the sum of the exclusive OR obtained by the operation unit.

(4) The optical recording medium driving apparatus according to (3), further including:

a pulling control unit that performs pulling control of a tracking servo based on a binarization signal obtained by the second binarizing unit.

The present disclosure contains subject matter related to that disclosed in Japanese Priority Patent Application JP 2012-048978 filed in the Japan Patent Office on Mar. 6, 2012, the entire content of which is hereby incorporated by reference.

What is claimed is:

1. An optical recording medium driving apparatus comprising:
a light radiating unit that radiates light to an optical recording medium;
a light receiving unit that receives reflection light from the optical recording medium, in which four regions including a first region, a second region, a third region, and a fourth region are formed by being divided by a linear direction division line extending in a direction corresponding to a longitudinal direction of a track formed in the optical recording medium and a tracking direction division line extending in a direction corresponding to a short-side direction of the track, the first region and the second region, and the third region and the fourth region being segmented by the linear direction division line, the first region and the fourth region, and the second region and the third region being segmented by the tracking direction division line, the first region and the second region being arranged on an upstream side based on an advancement direction of the track, and the third region and the fourth region being arranged on a downstream side based on the advancement direction of the track;
a first binarizing unit that obtains binarization signals based on light reception signals obtained in the respective first to fourth regions in the light receiving unit as a first signal, a second signal, a third signal, and a fourth signal, respectively;
a first exclusive OR calculating unit that calculates an exclusive OR of the first signal and the third signal;
a second exclusive OR calculating unit that calculates an exclusive OR of the second signal and the fourth signal; and
an operation unit that calculates a sum of the exclusive OR calculated by the first exclusive OR calculating unit and the exclusive OR calculated by the second exclusive OR calculating unit,
wherein the first and second exclusive OR calculating units and the operation unit operate in a state not synchronized with a channel clock.

2. The optical recording medium driving apparatus according to claim 1, further comprising:
a DC removing unit that removes a DC component of a signal as the sum of the exclusive OR obtained by the operation unit.

3. The optical recording medium driving apparatus according to claim 1, further comprising:
a second binarizing unit that binarizes a signal as the sum of the exclusive OR obtained by the operation unit.

4. The optical recording medium driving apparatus according to claim 3, further comprising:
a pulling control unit that performs pulling control of a tracking servo based on a binarization signal obtained by the second binarizing unit.

5. A cross track signal generation method comprising:
a light receiving procedure for receiving reflection light of light radiated to an optical recording medium by a light receiving unit in which four regions including a first region, a second region, a third region, and a fourth region are formed by being divided by a linear direction division line extending in a direction corresponding to a longitudinal direction of a track formed in the optical recording medium and a tracking direction division line extending in a direction corresponding to a short-side direction of the track, the first region and the second region, and the third region and the fourth region being segmented by the linear direction division line, the first region and the fourth region, and the second region and the third region being segmented by the tracking direction division line, the first region and the second region being arranged on an upstream side based on an advancement direction of the track, and the third region and the fourth region being arranged on a downstream side based on the advancement direction of the track, a first binarizing procedure for obtaining binarization signals based on light reception signals obtained in the respective first to fourth regions in the light receiving unit as a first signal, a second signal, a third signal, and a fourth signal, respectively;
a first exclusive OR calculating procedure for calculating an exclusive OR of the first signal and the third signal;
a second exclusive OR calculating procedure for calculating an exclusive OR of the second signal and the fourth signal; and
an operation procedure for calculating a sum of the exclusive OR calculated by the first exclusive OR calculating procedure and the exclusive OR calculated by the second exclusive OR calculating procedure,
wherein the calculation performed by the first and second exclusive OR calculating procedures and the operation procedure are executed in a state not synchronized with a channel clock.
